(19) United States
(12) Patent Application Publication
(10) Pub. No.: US 2025/0035451 A1
(43) Pub. Date: Jan. 30, 2025

(54) Route Planning Method for Large-scale Capacitated Arc Routing Problem

(71) Applicant: Jiangnan University, Wusi (CN)

(72) Inventors: Wei Fang, Wuxi (CN); Jianyang Zhu, Wuxi (CN); Hengyang Lu, Wuxi (CN); Shuwei Zhu, Wuxi (CN); Jun Sun, Wuxi (CN); Xiaojun Wu, Wuxi (CN)

(21) Appl. No.: 18/913,205

(22) Filed: Oct. 11, 2024

(30) Foreign Application Priority Data
Dec. 6, 2023 (CN) 202311677616.8

(51) Int. Cl. G01C 21/34

(52) U.S. Cl. CPC G01C 21/3453

(57) ABSTRACT

A route planning method for large-scale capacitated arc routing problem is disclosed, belonging to the field of combinatorial optimization. The present disclosure firstly performs global optimization and proposes a low-cost decomposition optimization solution based on CARP, which pertinently preserves more excellent decompositions during iterations. And, the present disclosure is also applied to a local search stage, and proposes an improved route construction rule. In a process of route insertion, a problem of excessive useless cost caused by a vehicle with almost full load returning to a depot is considered. After improvement, local search can be carried out more effectively, thus further improving the solution quality. Compared with an existing route planning method, the present disclosure considers details and characteristics of CARP optimization problems in a more detailed manner, thus achieving solutions with a lower cost and improving the stability by about two to three times.

### TECHNICAL FIELD

The present disclosure relates to a route planning method for large-scale capacitated arc routing problem, belonging to the field of combinatorial optimization.

### BACKGROUND

Arc Routing Problem (ARP) is a classic combinatorial optimization problem, whose main objective is to find a set of task routes in a given connected graph that satisfies all specific constraints, visits and serves all given task edges from a depot point, returns to the depot point, and ultimately minimizes a total cost of a vehicle. The ARP is initially abstracted from the Konigsberg Seven Bridges Problem, and its preliminary model is the Chinese Postman Problem. In real life and industrial production, the ARP is widely used in many scenarios, such as salt sprinkling and water truck route planning in cities, garbage recycling and cleaning planning, and winter snow removal route planning. All of these problems require reasonable route planning to reduce the transportation cost and improve efficiency. In winter, traffic accidents caused by road icing are a major challenge, and through reasonable road salt sprinkling planning, the probability of traffic accidents can be greatly reduced, thus ensuring the safety of people's lives and property. For example, in the UK, millions of pounds are spent annually on road salt sprinkling to prevent traffic accidents caused by road icing. In today's increasingly severe international resource crisis, designs of ARP related algorithms have a very positive promoting effect on scientific research and social production. By developing more efficient algorithms to solve ARP related problems, the efficiency and accuracy of route planning can be greatly improved, thus improving the efficiency and reducing the cost.

However, in real life, for vehicles that need to sprinkle salt on roads or water on streets, due to their limited capacity, it is difficult to serve all target roads at once and they must return to the depot point for supply. Therefore, based on the ARP, another core constraint condition needs to be introduced, which is capacity constraint. In 1981, Golden et al. added vehicle capacity as a more realistic constraint to the ARP, proposing a more practical model, i.e., an ARP with a capacity constraint, called Capacitated Arc Routing Problem (CARP). In the CARP, a sum of demands of all tasks in each route cannot exceed the capacity of the vehicles serving that route, which is the role of capacity constraint in the CARP. Compared with the ARP, the CARP with the capacity constraint is closer to practical application and has higher practical value. However, due to the addition of capacity constraint, difficulties in solving it have also significantly increased.

To solve the CARP, scholars have proposed various solving algorithms, which can be roughly divided into exact algorithms, heuristic algorithms, meta-heuristic algorithms, etc. Due to the limitation of only being able to solve small-scale CARPs, exact algorithms are difficult to effectively solve large-scale CARPs. Heuristic algorithms such as Augment-Merge, Path-Scanning and Ulusoy-Split can effectively solve small-scale and structurally simple problems, and can also serve as steps for generating initial solutions in complex algorithms. However, they still cannot handle large-scale CARPs alone. Meta-heuristic algorithms can be used for solving large-scale CARPs, such as Tabu Search, Evolution Algorithms, Simulated Annealing, Ant Colony System, and Memetic Algorithm. These algorithms can generally better integrate field knowledge and achieve better solutions, but require more computation resources. In recent years, algorithms based on divide and conquer strategies for solving LSCARPs have mostly relied on the Cooperative Co-evolution framework, and its theory has been applied to solve LSCARPs, such as RDG-MAENS (Y. Mei, X. Li, X. Yao. Cooperative Coevolution With Route Distance Grouping for Large-Scale Capacitated Arc Routing Problems [J]. IEEE Transactions on Evolutionary Computation, 2014, 18(3):435-449.), RRG (Y. Mei, X. Li, X. Yao. Decomposing Large-Scale Capacitated Arc Routing Problems using a random route grouping method [C]. 2013 IEEE Congress on Evolutionary Computation, 2013:1013-1020.), SAHiD (K. Tang, J. Wang, X. Li, et al. A Scalable Approach to Capacitated Arc Routing Problems Based on Hierarchical Decomposition [J]. IEEE Transactions on Cybernetics, 2017, 47(11):3928-3940.), RCO (Y. Zhang, Y. Mei, B. Zhang, et al. Divide-and-conquer large scale capacitated arc routing problems with route cutting off decomposition [J]. Information Sciences, 2021, 553:208-224), etc. Although a series of achievements have been made, there are still many challenges in solving CARPs, such as how to reasonably avoid invalid searches, how to deal with the exponential increase in time complexity caused by the increase in problem size, and so on.

Therefore, there is still significant room for development in the study on CARPs, and further in-depth research and exploration are needed.

### SUMMARY

In order to reduce the problems of high computation complexity, high computation cost, low planning efficiency and poor stability in an existing route planning method, the present disclosure provides a route planning method for large-scale capacitated arc routing problem, including:
step 1: acquiring route information required for a current application scenario, including a set of road endpoints V, a set of roads E, a demand de(e) and a traversing cost sc(e);
step 2: performing data pre-processing on the route information acquired in step 1, performing initialization to obtain a route solution sequence S and then performing global optimization through a low-cost route cutting off operator to obtain an optimized route solution sequence S₁;
step 3: randomly selecting n routes from the optimized route solution sequence S₁ and merging the n routes into a solution sequence S₂ that temporarily ignores a capacity constraint;
step 4: generating an empty route R starting from a depot supply point, using a greedy strategy to gradually insert tasks in the solution sequence S₂ obtained in step 3 into the empty route R in a case that a capacity of a vehicle is sufficient, prioritizing the insertion of a task that is the closest to a current visited task and ensuring randomness during the insertion; controlling the vehicle to return in a case that the capacity of the vehicle is consumed to a preset remaining capacity threshold; and
step 5: selecting a task route sequence that makes the cost the minimum during each iteration, and outputting an optimal task route sequence after reaching the maximum number of iterations.

Optionally, step 2 includes:
firstly, calculating the shortest distance between tasks:

$$Δ ( {t}_{1} , {t}_{2} ) = \frac{1}{4} ( δ ( hv ( {t}_{1} ) , hv ( {t}_{2} ) ) + δ ( hv ( {t}_{1} ) , tv ( {t}_{2} ) ) + δ ( tv ( {t}_{1} ) , hv ( {t}_{2} ) ) + δ ( tv ( {t}_{1} ) , tv ( {t}_{2} ) ) ) .$$

where t₁ and t₂ respectively represent two tasks, Δ(t₁,t₂) represents the shortest distance between tasks, and δ(V₁,V₂) represents the shortest reachable distance from an endpoint V₁ to V₂; and
traversing each sub-route; if a sum of demands of tasks is greater than a sum of useless costs, cutting off any two tasks only according to a probability of 5% to split an original route into two; and otherwise cutting off a task combination with the maximum useless cost in a target route according to a probability of 20%, and cutting off other task combinations according to a probability of 5%, that is:

$${\sum }_{t = 1}^{\vert t \vert} de ( t ) > {\sum }_{t = 1}^{\vert t \vert} sc ( t ) \to {S}^{′} ⋃ ( {S}_{k} , {S}_{k + 1} )$$

where t represents a number of each task in a set of solutions, S′ represents a set of new routes, and Sₖ and Sₖ+1 represent new routes generated by cutting off.

Optionally, step 3 includes: randomly selecting two positions l₁ and l₂ from the optimized route solution sequence S₁, selecting all tasks between l₁ and l₂ to form a set of new solutions based on the two positions, and ignoring the capacity constraint in a CARP in a process, where the set of new solutions is recombined into a set of original solutions after step 4.

Optionally, step 4 includes:
gradually inserting tasks into the selected route one by one starting from the depot point, and determining an inserted route based on a remaining capacity;
finally constructing five different feasible solutions through a Path-Scanning algorithm:

$$\begin{matrix}{t}_{next} = Max ( {V}_{t} , Depot ) ; & ( 1 ) \\ {t}_{next} = Min ( {V}_{t} , Depot ) ; & ( 2 ) \\ {t}_{next} = Max ( \frac{d ( t )}{sc ( t )} ) ; & ( 3 ) \\ {t}_{next} = Min ( \frac{d ( t )}{sc ( t )} ) ; & ( 4 )\end{matrix}$$

$$if {\sum }_{t = 0}^{t = i} dc ( t ) < \frac{1}{2} Q ,$$

(1) is used; otherwise, (2) is used,
where tₙₑₓₜ is a next task to be inserted, Vₜ represents a tail node of a current task, Depot represents the depot point, and Q represents the maximum capacity that a single vehicle is able to reach; and
after obtaining the five different feasible solutions, adding the capacity constraint again and selecting the solution with the minimum total cost as a final output solution.

Optionally, the process of determining an inserted route based on a remaining capacity includes:
selecting a task that is the closest to a current route to perform insertion in a case that the remaining capacity of a current vehicle satisfies the following condition:

$$rvc \geq α \times \frac{td}{ned}$$

where td/ned represents the average demand of tasks, td is the sum of demands of all tasks in the current route, ned is a sum of the total number of tasks in the route, and a is a custom parameter used for controlling the vehicle to return to the depot when a certain capacity is left, so as to avoid an excessive useless cost; and
inserting tasks that satisfy the following condition in a case that the remaining capacity of the current vehicle is less than

$$α \cdot \frac{td}{ned} :$$

$$SP ( {v}_{h} , {v}_{i} ) + c ( {v}_{i} , {v}_{j} ) + SP ( {v}_{h} , {v}_{i} ) \leq \frac{tc}{ned} + SP ( {v}_{h} , {v}_{0} )$$

where SP(vₕ,vᵢ) represents a length of a road currently served by the current vehicle, vₕ represents a head node of a current visited road, and vᵢ represents a tail node of the current visited road; c(vᵢ,vⱼ) represents the shortest reachable distance between the tail node of the current visited road and a next road that needs to be served, SP(vₕ,vᵢ) represents the shortest reachable distance between the next road that needs to be served and the depot supply point, and SP(vₕ,v₀) represents the shortest reachable distance between the head node of the current visited road and the depot point.

A second purpose of the present disclosure is to provide a city sprinkler truck route planning method, where the city sprinkler truck route planning method implements sprinkler truck operation route planning by adopting the route planning method for large-scale capacitated arc routing problem according to any one described above.

Optionally, route information required for sprinkler truck route planning includes a set of road endpoints, a set of roads, an amount of sprinkling water required for each road and a traversing cost of a sprinkler truck.

Optionally, a capacity constraint in sprinkler truck route planning is the maximum water load that a water tank of a single vehicle is able to reach.

Optionally, a depot point in sprinkler truck route planning is a water tank supply point of the sprinkler truck.

A third purpose of the present disclosure is to provide a computer-readable storage medium, the computer-readable storage medium storing a computer-executable instruction that, when executed by a processor, implements the method according to any one described above.

The present disclosure has the following beneficial effects:

By designing a low-cost oriented CARP cutting off and construction method for solving CARP or LSCARP, the route planning method of the present disclosure successfully reduces the solving cost of the traditional method, avoids some ineffective cost expenses, and improves the solution quality and performance of the method.

The method firstly is applied to the global optimization stage and proposes a low-cost decomposition optimization solution based on CARP, which pertinently preserves more excellent decompositions during iterations based on the structure of CARP and the decomposition experience of the previous study. The method is also applied to a local search stage, and proposes an improved route construction rule that optimizes a route insertion part in generating the initial solution. In a process of route insertion, a problem of excessive useless cost caused by the vehicle with almost full load returning to the depot is considered. After improvement, local search can be carried out more effectively, thus further improving the solution quality. Compared with the existing route planning method, the present disclosure considers the details and characteristics of CARP optimization problems in a more detailed manner, thus obtaining solutions with a lower cost, that is, reducing the computation complexity and computation cost, and improving the planning efficiency. As proved by experimental results, the present disclosure can improve the stability by about two to three times.

### BRIEF DESCRIPTION OF FIGURES

In order to describe the technical solutions in the embodiments of the present disclosure more clearly, the drawings required for the description of the embodiments will be briefly introduced below. Apparently, the drawings described below are only some embodiments of the present disclosure. For those skilled in the art, other drawings can be obtained based on these drawings without creative labor.

FIG. 1 illustrates a simple example graph of a CARP according to an embodiment of the present disclosure.

FIG. 2 illustrates an experimental line chart of parameter analysis in a route planning method according to an embodiment of the present disclosure.

FIG. 3 illustrates a flowchart of local search module in a route planning method according to an embodiment of the present disclosure.

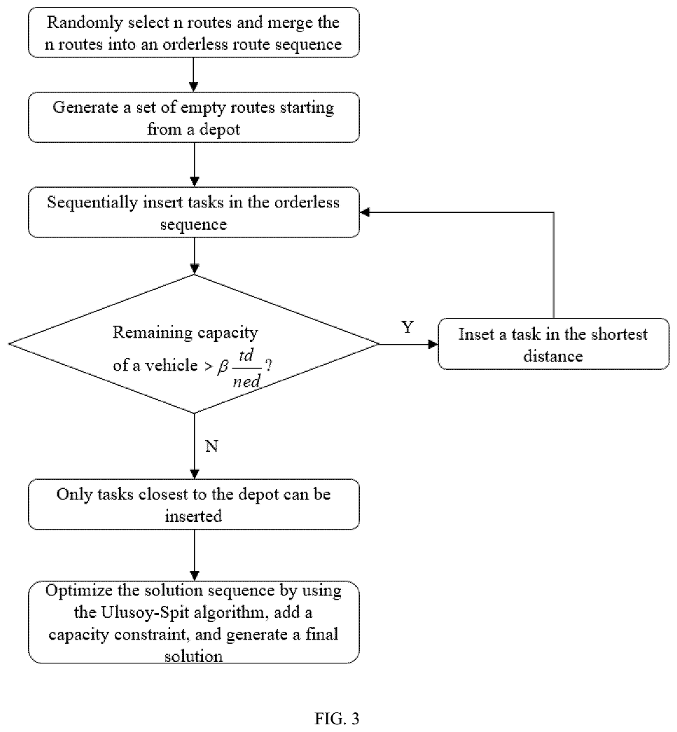

### DETAILED DESCRIPTION

In order to clarify the purposes, technical solutions and advantages of the present disclosure, the embodiments of the present disclosure will be further described in detail below with reference to the drawings.

### Embodiment 1

This embodiment provides a route planning method for large-scale capacitated arc routing problem, including the following steps:
In step 1, route information required for a current application scenario, including a set of road endpoints V, a set of roads E, a demand de(e) and a traversing cost sc(e), is acquired.
In step 2, data pre-processing is performed on the route information acquired in step 1, initialization is performed to obtain a solution sequence S, and then global optimization is performed through a low-cost route cutting off operator to obtain an optimized route solution sequence S₁.
In step 3, n routes are randomly selected from the optimized route solution sequence S₁ and the n routes are merged into a solution sequence S₂ that temporarily ignores a capacity constraint.

In step 4, an empty route R is generated starting from a depot supply point, a greedy strategy is used to gradually insert tasks in the solution sequence S₂ obtained in step 3 into the empty route R in a case that a capacity of a vehicle is sufficient, the insertion of task that is the closest to a current visited task is prioritized and randomness during the insertion is ensured; the vehicle is controlled to return in a case that the capacity of the vehicle is consumed to a preset remaining capacity threshold.

In step 5, a task route sequence that makes the cost the minimum is selected during each iteration, and an optimal task route sequence is output after reaching the maximum number of iterations.

### Embodiment 2

This embodiment provides a route planning method based on large-scale capacitated arc routing problem. Taking a city sprinkler truck route planning problem as an example, the method includes the following steps:

In step 1, a Capacitated Arc Routing Problem (CARP) in a context of the city sprinkler truck route planning problem is defined.

As defined by CARP, in a weighted undirected connected graph G(V,E), where V and E respectively represent a set of points and a set of edges, each edge e belonging to the set of edges E has three attributes, respectively demand de(e), serving cost sc(e) and traversing cost ce(e). The set of edges includes task edges and non-task edges, which are decided by the demand de. de(e)>0 represents a task edge, de(e)=0 represents a non-task edge, all edges with de(e)>0 form a set of tasks, and a set of all tasks is recorded as T={e∈E|d(e)>0}⊆E. The set of points V includes ordinary points and a depot point. The depot point is starting and ending points of vehicles. A set of vehicles with a maximum capacity Q at the depot point server all tasks. The objective of the CARP is to find a route with the minimum final cost while satisfying the capacity constraint, and satisfies the following conditions:
(1) The vehicle departs from the depot point and returns to the depot point after the service is completed.
(2) The task edge can only be served once, but can be traversed countless times.
(3) A sum of demands for task edges served by each vehicle cannot exceed its maximum capacity Q.

The solution of the CARP may be represented by a set of vertex sequences that represent the order of services. By adding the shortest routes between each pair of consecutive vertices, the minimum cost can be obtained. The solution of the CARP is composed of routes S=(R₁, . . . , Rₖ, . . . , Rₙ), where Rₖ represents the k-th route, k is the subscript of the route Rₖ, and n is a sum of the total number of routes in the solution. Each route Rₖ is composed of a set of task edges, represented as Rₖ=(tₖ₁, . . . , tₖₙ). Each task t may be represented by two IDs representing directions. Each ID respectively corresponds to a head node hv(t), a tail node tv(t) and an inverse ID inv(t). For example, for two IDs t₁ and t₂ of a certain task t, there are hv(t₁)=tv(t₂)=u, tv(t₁)=hv(t₂)=v, t₂=inv(t₁), and t₁=inv(t₂). The main optimization objective of this problem is as follow:

$$min Total Cost = {\sum }_{n = 1}^{\vert S \vert} {\sum }_{m = 1}^{\vert R \vert} [ sc ( {R}_{n} [ m ] ) + ( tv ( {R}_{n} [ m ] ) , hv ( {R}_{n} [ m + 1 ] ) ) ]$$

In the CARP in the context of city sprinkler truck route planning, the solution objective is to find a set of road visit sequences that minimize the cost of the entire process of sprinkler truck tasks within given city road network information, constrained by conditions such as the water tank capacity of the sprinkler truck.

Each road in a city corresponds to edgeE in the definition of the CARP, which has three major attributes, including demand de(e), serving cost sc(e) and traversing cost ce(e). The demand de(e) corresponds to an amount of sprinkling water required by each road, sc(e) corresponds to the serving cost of the sprinkler truck in serving the corresponding road, and the traversing cost ce(e) corresponds to the cost required for the sprinkler truck in traversing other roads, including fuel cost and the like. The starting point and ending point of each road represent the endpoints V in the CARP, the maximum capacity of the water tank of the sprinkler truck corresponds to the capacity constraint Q in the CARP, a set of all roads that need to be served corresponds to a set of tasks T={e∈E℄d(e)>0}⊆E, and the water tank supply point of the sprinkler truck corresponds to the depot point in the CARP. Therefore, the city sprinkler truck route planning problem can be solved and optimized by using the CARP model.

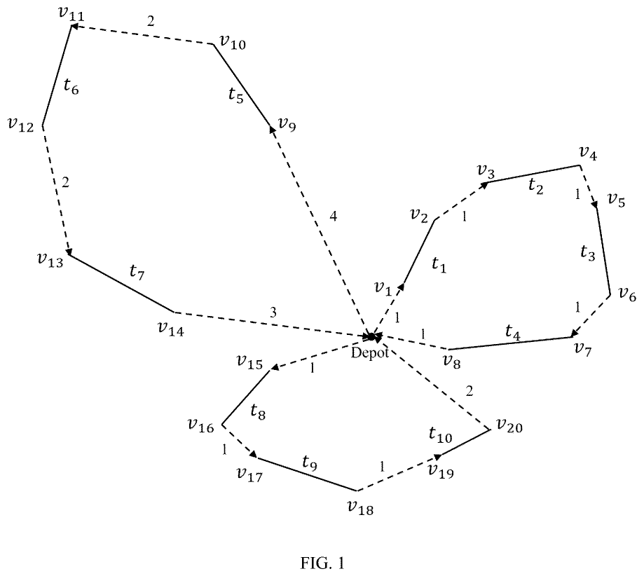

In step 2, route information required for a city sprinkler truck route planning application scenario, including a set of road endpoints V, a set of roads E, a demand de(e) and a traversing cost sc(e), is acquired, and all information is abstracted as a weighted undirected connected graph. FIG. 1 illustrates a simple example graph, in which three routes are given.

t₁ to t₁₀ are ten tasks in an example, where (t₁,t₂,t₃,t₄) forms a first route recorded as Route-1. Similarly, (t₅,t₆,t₇) and (t₈,t₉,t₁₀) are respectively recorded as Route-2 and Route-3. v₁ to v₁₅ are two endpoints of each task edge in the example. Depot represents the depot point, which is responsible for capacity supply when vehicles return.

In FIG. 1, the shortest distances between tasks are represented by dashed lines, and a length of each task edge is defaulted as 2. From FIG. 1, it can be seen that the number of tasks in Route-i is four, a sum of the shortest distances between all tasks is 1+1+1+1=4, and the task cost is 2+2+2+2=8; the number of tasks in Route-2 is three, the sum of the shortest distances between all tasks is 4+2+2+3=11, and the task cost is 2+2+2=8; the number of tasks in Route-3 is three, the sum of the shortest distances between all tasks is 1+1+1+2=5, and the task cost is 2+2+2=8. Therefore, in the process of serving Route-2, the vehicle produces an excessive useless cost. Similar routes are required to be decomposed in iterative optimization, so as to recombine and generate more promising excellent solutions.

In step 3, data pre-processing is performed on the route information acquired in step 2, initialization is performed to obtain a solution sequence S, and then global optimization is performed through a low-cost route cutting off operator.

Firstly, based on the length of each road in a target city, the distance between roads is calculated according to the following formula:

$$Δ ( {t}_{1} , {t}_{2} ) = \frac{1}{4} ( δ ( hv ( {t}_{1} ) , hv ( {t}_{2} ) ) + δ ( hv ( {t}_{1} ) , tv ( {t}_{2} ) ) + δ ( tv ( {t}_{1} ) , hv ( {t}_{2} ) ) + δ ( tv ( {t}_{1} ) , tv ( {t}_{2} ) ) ) .$$

where t₁,t₂ represents two different roads that need to be served, δ(hv(t₁),hv(t₂)) represents the distance between the head nodes of the two roads, δ(hv(t₁),tv(t₂)) represents the distance between the head node of road 1 and the tail node of road 2, δ(tv(t₁),hv(t₂)) represents the distance between the head node of road 2 and the tail node of road 1, and δ(tv(t₁),tv(t₂)) represents the distance between the tail nodes of the two roads.

Initialization is performed on the existing data to obtain a legal route sequence S, i.e., a set of road visit orders that satisfy the capacity constraint. The water tank supply point will appear multiple times due to the presence of the capacity constraint.

Due to the presence of the capacity constraint, the sprinkler truck needs to start from the supply point, return for supply when the water tank is empty, and then start for operation again. This process is repeated or multiple sprinkler trucks execute tasks in parallel. Therefore, globally, the process of sprinkling water on all roads is divided into multiple sub-routes. Each sub-route is traversed. If a sum of demands de of current road tasks is greater than a sum of useless costs sc, any two tasks are cut off only according to a probability of 5% to split an original route into two.

$${\sum }_{t = 1}^{\vert t \vert} de ( t ) > {\sum }_{t = 1}^{\vert t \vert} sc ( t ) \to {s}^{′} ⋃ ( {S}_{k} , {S}_{k + 1} )$$

where t represents the serial number of each road in the current route, S′ represents a set of new routes obtained after optimization, and Sₖ and Sₖ₊₁ represent new routes generated by cutting off.

Otherwise, a task combination with the maximum useless cost in a target route, i.e., two roads with adjacent visit orders, is cut off according to a probability of 20%, and then other task combinations are cut off according to a probability of 5%.

Finally, a set of optimized routes obtained in step 3 is recorded as S₁.

In step 4, n routes are randomly selected from the set of optimized routes S₁ and the n routes are merged into a solution sequence S₂ that temporarily ignores the capacity constraint. In the sprinkler truck route planning application scenario, two task serial numbers are randomly selected from the solution sequence S₁ as positions l₁ and l₂. Based on these two positions, all roads between l₁ and l₂ are selected to form a new road visit sequence, which serves as the main target object for next optimization. In addition, in this process, the capacity constraint in the CARP is temporarily ignored, that is, the capacity of the water tank is temporarily ignored.

In step 5, a set of empty routes R is generated starting from the depot supply point of the sprinkler truck, a specific greedy strategy is used to gradually insert a route that is the closest to the current served road and needs to be served in S₂ into R in a case that the capacity of the water tank of the current vehicle is sufficient, and randomness during the insertion is ensured; a low-cost return strategy is adopted in a case that the capacity of the water tank of the vehicle is consumed to a certain extent.

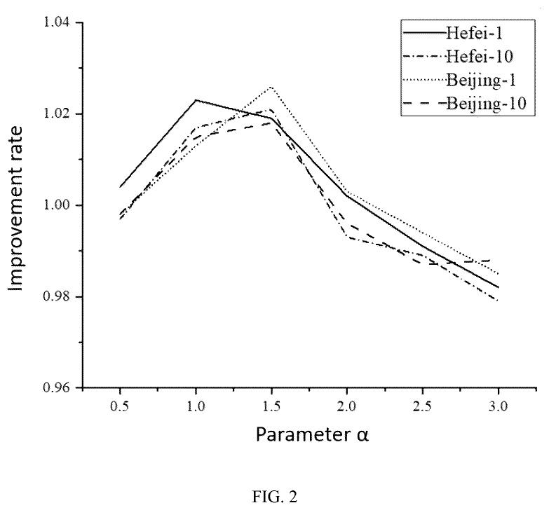

Specifically, starting from the sprinkler truck supply point, tasks are gradually inserted into the target route one by one. In a case that the remaining capacity of the water tank of the current vehicle satisfies the following condition, the road that is the closest to the current route and needs to be served is selected to perform insertion:

$$rvc \geq α \times \frac{td}{ned}$$

where rvc represents the remaining capacity of the water tank of the current vehicle, td/ned represents the average demand of roads that need to be served in the current route, td is the sum of demands of all roads that need to be served in the current route, ned is a sum of the total number of roads that need to be served in the route, and a is a custom parameter used for controlling the vehicle to return to the depot when a certain capacity is left, so as to avoid an excessive useless cost. For related parameter analysis experiments, see FIG. 2.

Tasks that satisfy the following condition are only inserted in a case that the remaining capacity of the current vehicle is less than

$$α \cdot \frac{td}{ned} :$$

$$SP ( {v}_{h} , {v}_{i} ) + c ( {v}_{i} , {v}_{j} ) + SP ( {v}_{h} , {v}_{i} ) \leq \frac{tc}{ned} + SP ( {v}_{h} , {v}_{0} )$$

where SP(vₕ,vᵢ) represents the length of the road currently served by the current vehicle, vₕ represents a head node of the current visited road, and vᵢ represents a tail node of the current visited road; c(vᵢ,vⱼ) represents the shortest reachable distance between the tail node of the current visited road and a next road that needs to be served, SP(vₕ,vᵢ) represents the shortest reachable distance between the next road that needs to be served and the depot supply point, and SP(vₕ,v₀) represents the shortest reachable distance between the head node of the current visited road and the depot point. That is, in a case that the capacity of the current vehicle decreases to a certain extent, the road close to the depot point will be visited at a next time. Finally, five different feasible solutions are constructed through the Path-Scanning algorithm:

$$\begin{matrix}{t}_{next} = Max ( {V}_{t} , Depot ) ; & ( 1 ) \\ {t}_{next} = Min ( {V}_{t} , Depot ) ; & ( 2 ) \\ {t}_{next} = Max ( \frac{d ( t )}{sc ( t )} ) ; & ( 3 ) \\ {t}_{next} = Min ( \frac{d ( t )}{sc ( t )} ) ; & ( 4 )\end{matrix}$$

$$if {\sum }_{t = 0}^{t = i} dc ( t ) < \frac{1}{2} Q , \qquad ( 5 )$$

(1) is used; otherwise, (2) is used.

For the Path-Scanning algorithm, a reference may be made to “B. L. Golden, J. S. DeArmon, E. K. Baker. Computational experiments with algorithms for a class of routing problems [J]. Computers & Operations Research, 1983, 10(1):47-59”; tₙₑₓₜ is a next road to be inserted and to be served, Vₜ represents a tail node of the current road, Depot represents a depot point to which the vehicle returns for supply after the capacity of the water tank is completely consumed, and Q is the capacity constraint in the CARP and represents the maximum capacity that the water tank of a single vehicle is able to reach.

After the five different feasible solutions are constructed, the following operations are performed respectively on the five different feasible solutions. Firstly, the visit order of all roads is fixed and the capacity constraint of the vehicle is ignored to transform the sets of loops into a huge loop. Then, optimization is performed by using the Ulusoy-Split algorithm, and then the capacity constraint is added again. Finally, the five sets of loops are combined with loops that are not selected in the merging stage to construct five different complete solutions, and the solution with the minimum total cost is used as a final output solution. After the above operations, a set of new solutions is generated and reinserted between positions l₁ and l₂ to generate and output a final solution for this iteration.

Step 5 belongs to the local search part of the city sprinkler truck route planning problem, while step 3 belongs to the global optimization part. The local search algorithm and the global search algorithm each have its own advantages and disadvantages. The global search algorithm is suitable for performing large-scale search operations in scenarios with large solution spaces, so as to mine more regions with higher search value. However, the weakness of the global search algorithm is its poor ability to perform detailed searches within a single limited area. Unlike the global search algorithm, the local search algorithm is suitable for conducting detailed searches in a small local area, so as to more accurately search for a local optimal solution within this range. Therefore, the present disclosure adopts a low-cost optimization method combining global optimization and local search to solve the target problem.

For the Ulusoy-Split algorithm, a reference may be made to the introduction in “G. Ulusoy. The fleet size and mix problem for capacitated arc routing [J]. European Journal of Operational Research, 1985, 22(3):329-337”. The introduction to the principle is omitted here.

In step 5, the present disclosure abstracts the road network of the target city into a CARP model for input, and then iteratively outputs a better solution. The first iteration constructs a feasible solution through initialization, and after each iteration, the current optimal solution is saved as the basis for the next iteration. If the optimal value of multiple iterations fails to improve, the nearest suboptimal solution is accepted and subsequent iterations are continuously performed.

In order to further demonstrate the beneficial effects of the present disclosure, a series of experiments were conducted to verify the superiority of the method of the present disclosure.

Firstly, the specific application scenarios of experiments in the present disclosure will be introduced. The first application scenario is a dataset obtained from the road network in Hefei, China, and the second application scenario is a dataset obtained from the road network within the Fifth Ring Road in Beijing, both of which have a large scale. Dataset Hefei has 850 endpoints and 1212 roads, including 10 examples to reflect the differences in the roads that need to be served on different workdays. Dataset Beijing consists of 2820 points and 3584 roads, including 10 examples. The scale of dataset Beijing is larger than that of dataset Hefei. The number of tasks in the two datasets was increased from 10% of the edges to 100%, with an increment of 10%. Table 1 and Table 2 provide detailed information about the datasets, where |V| is the number of points in the example, |E| is the number of edges, |T| is the number of task edges, Q is the capacity of a vehicle, and M is the minimum number of vehicles required to perform all tasks.

The information of the two road networks in Beijing and Hefei was abstracted into input information for processing through the method in step 2. After obtaining the information on the practical application scenarios, in order to better reflect the task distribution of sprinkler trucks in actual work, different task distributions were set for different examples in the datasets used. This is because in the actual process of task execution, the roads that need to be served every day are usually different, and setting different task distributions can also better verify the stability of the proposed method.

TABLE 1
example information of dataset Hefei

| | | | | Proportion | | |
|---|---|---|---|---|---|---|
| Name | \|V\| | \|E\| | \|T\| | of tasks | Q | M |
| Hefei-1 | 850 | 1212 | 121 | 10% | 9000 | 7 |
| Hefei-2 | 850 | 1212 | 242 | 20% | 9000 | 14 |
| Hefei-3 | 850 | 1212 | 364 | 30% | 9000 | 19 |
| Hefei-4 | 850 | 1212 | 485 | 40% | 9000 | 28 |
| Hefei-5 | 850 | 1212 | 606 | 50% | 9000 | 35 |
| Hefei-6 | 850 | 1212 | 727 | 60% | 9000 | 42 |
| Hefei-7 | 850 | 1212 | 848 | 70% | 9000 | 49 |
| Hefei-8 | 850 | 1212 | 970 | 80% | 9000 | 56 |
| Hefei-9 | 850 | 1212 | 1091 | 90% | 9000 | 63 |
| Hefei-10 | 850 | 1212 | 1212 | 100% | 9000 | 69 |

TABLE 2
example information of dataset Beijing

| | | | | Proportion | | |
|---|---|---|---|---|---|---|
| Name | \|V\| | \|E\| | \|T\| | of tasks | Q | M |
| Beijing-1 | 2820 | 3584 | 358 | 10% | 9000 | 7 |
| Beijing-2 | 2820 | 3584 | 717 | 20% | 9000 | 11 |
| Beijing-3 | 2820 | 3584 | 1075 | 30% | 9000 | 18 |
| Beijing-4 | 2820 | 3584 | 1433 | 40% | 9000 | 23 |
| Beijing-5 | 2820 | 3584 | 1792 | 50% | 9000 | 30 |
| Beijing-6 | 2820 | 3584 | 2151 | 60% | 9000 | 36 |
| Beijing-7 | 2820 | 3584 | 2509 | 70% | 9000 | 41 |
| Beijing-8 | 2820 | 3584 | 2868 | 80% | 9000 | 47 |
| Beijing-9 | 2820 | 3584 | 3226 | 90% | 9000 | 52 |
| Beijing-10 | 2820 | 3584 | 3584 | 100% | 9000 | 58 |

The following experiments were designed. Comparative experiments were conducted between the proposed method and existing excellent methods such as RDG-MAENS, VNS, TSA-1 and SAHiD on datasets Hefei and Beijing. In the above experiments, in order to conduct a fair comparison, both the algorithm proposed in the present disclosure and the comparative algorithms were tested on the same datasets Hefei and Beijing. The parameter settings of all comparative methods were consistent with those in the original paper, which were the same as the settings above. The parameter settings of the comparative algorithms were consistent with those in the original text. The comparison standard was the minimum cost of the algorithm within the limited running time. The maximum running time was set to 2492 seconds. Finally, the Wilcoxon rank-sum test was conducted, where α=0.05.

Table 3 shows a comparison between averages obtained after the proposed method and other algorithms run 20 times on dataset Hefei, while Table 4 shows a comparison between averages obtained after the proposed method and other algorithms run 20 times on dataset Beijing. The tables show the averages and standard deviations of the proposed method and the comparative methods. The underlined ones represent that the algorithm achieved the best results in the same example. The method proposed in the present disclosure improves the solution quality by using a low-cost route optimization method, and respectively adopting a low-cost route cutting off solution in the global optimization stage and a low-cost route construction rule in the local search stage.

TABLE 3
comparison between averages obtained after the method of the present
disclosure and other algorithms run 20 times on dataset Hefei

| | Average/standard | | | | | The present |
|---|---|---|---|---|---|---|
| Example | deviation | VNS | RDG-MAENS | TSA-1 | SAHiD | disclosure |
| Hefei-1 | Average | 247819 | 247389 | 252615 | 251024 | 246551 |
| | Standard deviation | 2745 | 2301 | 1591 | 1820 | 220 |
| Hefei-2 | Average | 449979 | 441602 | 456228 | 445376 | 435153 |
| | Standard deviation | 5375 | 4257 | 5539 | 2476 | 830 |
| Hefei-3 | Average | 595263 | 589183 | 637201 | 590969 | 582537 |
| | Standard deviation | 3108 | 2656 | 8003 | 2305 | 753 |
| Hefei-4 | Average | 774323 | 761387 | 791790 | 759402 | 749812 |
| | Standard deviation | 6394 | 4337 | 5481 | 2495 | 1032 |
| Hefei-5 | Average | 994794 | 991807 | 1042701 | 976276 | 959351 |
| | Standard deviation | 6109 | 5769 | 11496 | 4742 | 1265 |
| Hefei-6 | Average | 1128667 | 1132123 | 1162641 | 1106735 | 1093215 |
| | Standard deviation | 9404 | 9001 | 13806 | 5318 | 2350 |
| Hefei-7 | Average | 1337353 | 1361180 | 1353502 | 1309474 | 1293862 |
| | Standard deviation | 6745 | 14337 | 6235 | 4792 | 2173 |
| Hefei-8 | Average | 1517151 | 1550664 | 1537169 | 1483694 | 1456511 |
| | Standard deviation | 12477 | 13619 | 6709 | 4857 | 2956 |
| Hefei-9 | Average | 1694957 | 1749132 | 1716256 | 1659700 | 1624688 |
| | Standard deviation | 10164 | 18842 | 9236 | 6103 | 2552 |
| Hefei-10 | Average | 1852622 | 1923290 | 1901167 | 1808860 | 1789126 |
| | Standard deviation | 10183 | 31823 | 12679 | 7836 | 3576 |
| W-D-L | | 10-0-0 | 10-0-0 | 10-0-0 | 10-0-0 | |

TABLE 4
comparison between averages obtained after the method of the present
disclosure and other algorithms run 20 times on dataset Beijing

| | Average/standard | | | | | The present |
|---|---|---|---|---|---|---|
| Example | deviation | VNS | RDG-MAENS | TSA-1 | SAHiD | disclosure |
| Beijing-1 | Average | 782415 | 829443 | 829132 | 784737 | 765652 |
| | Standard deviation | 4452 | 12723 | 6340 | 5591 | 2294 |
| Beijing-2 | Average | 1192292 | 1338002 | 1401363 | 1183955 | 1153945 |
| | Standard deviation | 10196 | 19020 | 25378 | 8431 | 4256 |
| Beijing-3 | Average | 1618484 | 1847973 | 1709279 | 1605846 | 1551386 |
| | Standard deviation | 11888 | 33061 | 14801 | 9231 | 5023 |
| Beijing-4 | Average | 1953892 | 2193427 | 2070885 | 1936994 | 1889213 |
| | Standard deviation | 16746 | 34102 | 14532 | 11694 | 7403 |
| Beijing-5 | Average | 2335915 | 2639486 | 2440319 | 2298630 | 2232615 |
| | Standard deviation | 23040 | 32265 | 26726 | 16879 | 7186 |
| Beijing-6 | Average | 2743677 | 3047311 | 2814735 | 2707500 | 2635156 |
| | Standard deviation | 18024 | 41063 | 22018 | 18433 | 8243 |
| Beijing-7 | Average | 3063813 | 3388275 | 3186240 | 3038157 | 2934686 |
| | Standard deviation | 25226 | 26198 | 22426 | 15658 | 9569 |
| Beijing-8 | Average | 3366215 | 3697052 | 3456037 | 3313590 | 3214895 |
| | Standard deviation | 24686 | 45065 | 22381 | 21925 | 11876 |
| Beijing-9 | Average | 3723830 | 4061820 | 3943883 | 3684250 | 3545621 |
| | Standard deviation | 45148 | 49476 | 37089 | 32404 | 10835 |
| Beijing-10 | Average | 4040694 | 4353974 | 4103532 | 4004310 | 3836132 |
| | Standard deviation | 27384 | 51162 | 15501 | 29488 | 12168 |
| W-D-L | | 10-0-0 | 10-0-0 | 10-0-0 | 10-0-0 | |

Based on the experimental results, it can be concluded that this embodiment can achieve significantly better results than the comparative algorithms VNS, RDG-MAENS, TSA-1, and SAHiD in all examples of the two datasets. Moreover, in terms of the stability of the experimental results, this embodiment can improve it by two to three times. To sum up, this embodiment has verified its effectiveness in optimizing city road sprinkler truck route planning through comparative experiments conducted.

Some of the steps in the embodiments of the present disclosure may be implemented by using software, and the corresponding software programs may be stored in readable storage media, such as CDs or hard drives.

What are described above are only preferred embodiments of the present disclosure and are not intended to limit the present disclosure. Any modifications, equivalent replacements, improvements and the like made within the spirit and principle of the present disclosure should be all included in the scope of protection of the present disclosure.

What is claimed is:

1. A route planning method for large-scale capacitated arc routing problem, comprising:
step 1: acquiring route information required for a current application scenario, comprising a set of road endpoints V, a set of roads E, a demand de(e) and a traversing cost sc(e);
step 2: performing data pre-processing on the route information acquired in step 1, performing initialization to obtain a route solution sequence S, and then performing global optimization through a low-cost route cutting off operator to obtain an optimized route solution sequence S₁;
step 3: randomly selecting n routes from the optimized route solution sequence S₁ and merging the n routes into a solution sequence S₂ that temporarily ignores a capacity constraint;
step 4: generating an empty route R starting from a depot supply point, using a greedy strategy to gradually insert tasks in the solution sequence S₂ obtained in step 3 into the empty route R in a case that a capacity of a vehicle is sufficient, prioritizing the insertion of a task that is the closest to a current visited task and ensuring randomness during the insertion; controlling the vehicle to return in a case that the capacity of the vehicle is consumed to a preset remaining capacity threshold; and
step 5: selecting a task route sequence that makes the cost the minimum during each iteration, and outputting an optimal task route sequence after reaching the maximum number of iterations,
step 4 comprising:
gradually inserting tasks into the selected route one by one starting from the depot point, and determining an inserted route based on a remaining capacity;
finally constructing five different feasible solutions through a Path-Scanning algorithm:
$$\begin{matrix}{t}_{next} = Max ( {V}_{t} , Depot ) ; & ( 1 ) \\ {t}_{next} = Min ( {V}_{t} , Depot ) ; & ( 2 ) \\ {t}_{next} = Max ( \frac{d ( t )}{sc ( t )} ) ; & ( 3 ) \\ {t}_{next} = Min ( \frac{d ( t )}{sc ( t )} ) ; & ( 4 )\end{matrix}$$
$$if {\sum }_{t = 0}^{t = i} dc ( t ) < \frac{1}{2} Q , \qquad ( 5 )$$
(1) is used; otherwise, (2) is used,
where tₙₑₓₜ is a next task to be inserted, Vₜ represents a tail node of a current task, Depot represents the depot point, and Q represents the maximum capacity that a single vehicle is able to reach; and
after obtaining the five different feasible solutions, adding the capacity constraint again and selecting the solution with the minimum total cost as a final output solution.

2. The method according to claim 1, wherein step 2 comprises:
Firstly, calculating the shortest distance between tasks:
$$Δ ( {t}_{1} , {t}_{2} ) = \frac{1}{4} ( δ ( hv ( {t}_{1} ) , hv ( {t}_{2} ) ) + δ ( hv ( {t}_{1} ) , tv ( {t}_{2} ) ) + δ ( tv ( {t}_{1} ) , hv ( {t}_{2} ) ) + δ ( tv ( {t}_{1} ) , tv ( {t}_{2} ) ) )$$
where t₁ and t₂ respectively represent two tasks, Δ(t₁,t₂) represents the shortest distance between tasks, and δ(V₁,V₂) represents the shortest reachable distance from endpoints V₁ to V₂; and
traversing each sub-route; if a sum of demands of tasks is greater than a sum of useless costs, cutting off any two tasks only according to a probability of 5% to split an original route into two; and otherwise cutting off a task combination with the maximum useless cost in a target route according to a probability of 20%, and cutting off other task combinations according to a probability of 5%, that is:
$${\sum }_{t = 1}^{\vert t \vert} de ( t ) > {\sum }_{t = 1}^{\vert t \vert} sc ( t ) \to {s}^{′} ⋃ ( {S}_{k} , {S}_{k + 1} )$$
where t represents a number of each task in a set of solutions, S′ represents a set of new routes, and
Sₖ and Sₖ₊₁ represent new routes generated by cutting off.

3. The method according to claim 2, wherein step 3 comprises: randomly selecting two positions l₁ and l₂ from the optimized route solution sequence S₁, selecting all tasks between l₁ and l₂ to form a set of new solutions based on the two positions, and ignoring the capacity constraint in a CARP in a process, wherein the set of new solutions is recombined into a set of original solutions after step 4.

4. The method according to claim 3, wherein the process of determining an inserted route based on a remaining capacity comprises:
selecting a task that is the closest to a current route to perform insertion in a case that the remaining capacity of a current vehicle satisfies the following condition:
$$rvc \geq α \times \frac{td}{ned}$$
where td/ned represents the average demand of tasks, td is the sum of demands of all tasks in the current route, ned is a sum of the total number of tasks in the route, and a is a custom parameter used for controlling the vehicle to return to the depot when a certain capacity is left, so as to avoid an excessive useless cost; and
inserting tasks that satisfy the following condition in a case that the remaining capacity of the current vehicle is less than
$$α \cdot \frac{td}{ned} :$$
$$SP ( {v}_{h} , {v}_{i} ) + c ( {v}_{i} , {v}_{j} ) + SP ( {v}_{h} , {v}_{i} ) \leq \frac{tc}{ned} + SP ( {v}_{h} , {v}_{0} )$$
where SP(vₕ,vᵢ) represents a length of a road currently served by the current vehicle, vₕ represents a head node of a current visited road, and vᵢ represents a tail node of the current visited road; c(vᵢ,v₁) represents the shortest reachable distance between the tail node of the current visited road and a next road that needs to be served, SP(vₕ,vᵢ) represents the shortest reachable distance between the next road that needs to be served and the depot supply point, and SP(vₕ,v₀) represents the shortest reachable distance between the head node of the current visited road and the depot point.

5. A city sprinkler truck route planning method, wherein the city sprinkler truck route planning method implements sprinkler truck operation route planning by adopting the route planning method for large-scale capacitated arc routing problem according to claim 1.

6. The city sprinkler truck route planning method according to claim 5, wherein route information required for sprinkler truck route planning comprises a set of road endpoints, a set of roads, an amount of sprinkling water required for each road and a traversing cost of a sprinkler truck.

7. The city sprinkler truck route planning method according to claim 5, wherein a capacity constraint in sprinkler truck route planning is the maximum water load that a water tank of a single vehicle is able to reach.

8. The city sprinkler truck route planning method according to claim 5, wherein a depot point in sprinkler truck route planning is a water tank supply point of the sprinkler truck.

9. A computer-readable storage medium, the computer-readable storage medium storing a computer-executable instruction that, when executed by a processor, implements the method according to claim 1.
